(19) United States
(12) Patent Application Publication
(10) Pub. No.: US 2004/0174458 A1
(43) Pub. Date: Sep. 9, 2004

(54) Image reproduction apparatus and method

(76) Inventor: Toshiyuki Okubo, Tokyo (JP)

Correspondence Address: MORGAN & FINNEGAN, L.L.P., 345 PARK AVENUE, NEW YORK, NY, 10154, US

(21) Appl. No.: 10/774,254

(22) Filed: Feb. 5, 2004

(30) Foreign Application Priority Data
Feb. 7, 2003 (JP) 2003-030383

(51) Int. Cl. H04N 11/02

(52) U.S. Cl. 348/397.1; 348/398.1

(57) ABSTRACT

The present invention provides an image reproduction apparatus and method including a recording medium that stores a plurality of image files having a file structure that contains a first image and a second image that is a low-resolution version of the first image, a display unit that displays an image according to the plurality of image file stores on the recording medium, and an operating unit operated by a user for fast forwarding images displayed on the display unit. While the operating unit is in a predetermined operating state, the second images in the plurality of image files are continuously fast forwarded. When the operating unit is released from the predetermined operating state, the display unit displays a first, high-resolution image corresponding to a second, low-resolution image displayed a predetermined number of images before the second image displayed when the operating unit is released from that predetermined operating state.

### FIELD OF THE INVENTION

The present invention relates to an image reproduction apparatus and method, and more particularly, to an image reproduction apparatus and method that reproduces electronically recorded still and moving images on a display device.

### BACKGROUND OF THE INVENTION

Recently, a technology has been proposed in which a still image or moving image is sensed with image sensing elements, the still image or moving image so sensed is recorded onto a recording medium such as a memory card composed of solid-state memory elements and the recorded still or moving images are reproduced.

Image reproduction apparatuses such as electronic cameras and the like, equipped with an image sensing function that electronically records and reproduces such still and moving images, are already available in the ordinary market. It should be noted that, in the description that follows, such “still images” or “moving images” are referred to simply as “images” as necessary.

Typically, image reproduction apparatuses such as those noted above are equipped with a liquid crystal display panel such as a color liquid crystal panel or the like, which is used to provide the user with an electronic viewfinder function for confirming the image to be sensed, and a reproduction image display function for confirming the contents of the image file after sensing.

More specifically, the electronic viewfinder function allows the subject image to be displayed on the liquid crystal display panel, enabling the user to set the composition of the picture while looking at the displayed image.

Similarly, the reproduction image display function allows the sensed image to be reproduced and displayed on the liquid crystal display panel, enabling the user to determine whether or not the desired image has been taken.

With a large-capacity memory card, a large number of images can be recorded as image files. In this case, with a reproduction image display function like that described above, in order to reproduce a particular image from among the large number of images recorded in the large-capacity memory card, the user must search for that particular image among that large number of image files.

Accordingly, an electronic camera has been proposed that has a fast forward function such that, by continuously pressing a key for the display of images one after another, the images are continuously displayed one after another on the liquid crystal display panel. Users have supported electronic cameras having such a fast forward function because these cameras enable users to find a particular image efficiently among a large number of recorded images.

Moreover, this fast forward function is disclosed, for example, in the specification of U.S. Pat. No. 5,933,137, in which both low-resolution images and high-resolution images are contained in one image file. The aforementioned low-resolution images are then continuously displayed one after another on the liquid crystal display panel as long as the user keeps pressing a function key.

Thereafter, when the user then stops pressing the key, a high-resolution image corresponding to the low-resolution images displayed at that moment (that is, the high-resolution image stored in the same image file together with the aforementioned low-resolution image) is displayed on the liquid crystal display panel, in accordance with the resolution of the liquid crystal display panel.

The fast-forwarding structure described above makes it possible to fast forward the images at high speed by fast forwarding and displaying low-resolution images (which do not require time for decompression) one after another on the liquid crystal display panel, and displaying an image that the user wants to see by decompressing the high-resolution image that corresponds to the low-resolution image displayed at the time the user stops the fast forward, in the form of an image optimal for the resolution of a given liquid crystal display panel.

It should be noted that storage of both low-resolution images and high-resolution images in a single file is itself described in the specification of U.S. Pat. No. 5,164,831.

Thus, with image reproduction apparatuses such as the conventional electronic camera, a particular image can be searched for among a large number of images using a fast forward function executed by continuously pressing a key for displaying images in fast forward fashion. Then, when the target low-resolution image is displayed, the key is released and the fast forward is stopped.

However, because the speed with which the low-resolution images are fast forwarded is very high, the user often releases the fast forward key 1-2 frames past the target image. In such cases, after the fast forward is stopped, it is necessary to back up until the target image is displayed, which is inconvenient to the user.

Thus, with the conventional technology, it is difficult to search quickly and efficiently for a particular image among a plurality of images.

### SUMMARY OF THE INVENTION

Accordingly, the present invention has been conceived in light of the foregoing considerations, and provides an apparatus and method for quickly and easily searching for a particular image among a plurality of images.

According to one aspect of the present invention, there is provided an image reproduction apparatus having a memory that stores a plurality of image files, a display unit that displays images according to the plurality of image files stored in the memory, an operating unit operated by the user for fast forwarding images displayed on the display unit, and a control unit that displays an image according to one of the plurality of image files on the display unit according to the operations of the operating unit.

Preferably, each of the plurality of image files has a file structure in which the file contains at least a first image and a second image that is a low-resolution version of the first image.

Preferably, the control unit successively displays in fast forward the second, low-resolution images according to the plurality of image files while the operating unit is in a predetermined operating state, and displays a first image corresponding to a second low-resolution image displayed a predetermined number of images prior to the second low-resolution image displayed when the operating unit is released from the predetermined operating state.

According to another aspect of the present invention, there is provided an image reproduction method for an image reproduction apparatus. The apparatus has a memory that stores a plurality of image files having a file structure in which the file contains at least a first image and a second image that is a low-resolution version of the first image, a display unit that displays images according to the plurality of image files stored in the memory, and an operating unit, operated by the user, for fast forwarding images displayed on the display unit. The image reproduction method includes the steps of successively displaying in fast forward the second low-resolution images according to the plurality of image files while the operating unit is in a predetermined operating state, and displaying a first image corresponding to a second low-resolution image displayed a predetermined number of images prior to the second low-resolution image displayed when the operating unit is released from the predetermined operating state.

Other objects, features and advantages of the present invention will be apparent from the following description, taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing one example of the configuration of an image reproduction apparatus according to an embodiment of the present invention;

FIG. 2 is a diagram showing an external view mainly of a rear surface of an image reproduction apparatus according to an embodiment of the present invention;

FIG. 3 is a diagram showing one example of a file structure of an image file recorded by an image reproduction apparatus according to an embodiment of the present invention; and

FIG. 4 is a flow chart illustrating operation during a reproduction mode of an image reproduction apparatus according to an embodiment of the present invention.

### DETAILED DESCRIPTION OF THE PREFERRED EMBODIMENTS

A preferred embodiment of the present invention is described in detail in accordance with the accompanying drawings.

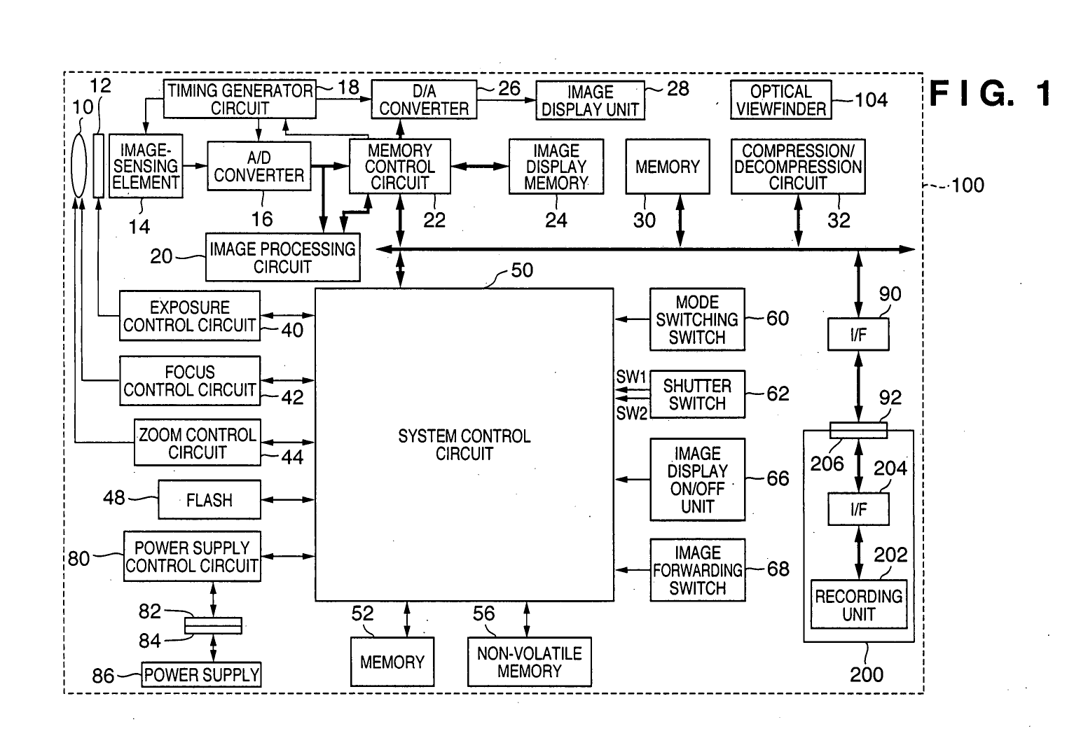

FIG. 1 is a block diagram showing one example of the configuration of an image reproduction apparatus according to an embodiment of the present invention. In FIG. 1, reference numeral 100 denotes the image reproduction apparatus as a whole. Reference numeral 10 denotes an image-sensing lens. Reference numeral 12 denotes a shutter equipped with a focus function. Reference numeral 14 denotes an image-sensing element that converts an optical image into an electrical signal. Reference numeral 16 denotes an A/D converter that converts the analog signal output from the image-sensing element 14 into a digital signal.

Reference numeral 18 denotes a timing generator circuit that supplies clock signals and control signals to the image-sensing element 14, the A/D converter 16 and a D/A converter 26. The timing generator circuit 18 is itself controlled by a memory control circuit 22 and a system control circuit 50.

Reference numeral 20 denotes an image processing circuit. The image processing circuit 20 performs predetermined pixel interpolation and color conversion processes on data from the A/D converter 16 or on data from the memory control circuit 22.

Additionally, the image processing circuit 20 performs predetermined calculations using the acquired image data. Then, based on the results obtained by that calculation process, the system control circuit 50 causes an exposure control circuit 40 and a focus control circuit 42 to perform commonly known auto exposure and auto focus operations, respectively.

Additionally, the image processing circuit 20 performs predetermined calculations using the acquired image data and, based on the results obtained by that calculation process, carries out a commonly known AWB (auto white balance) operation. In addition, based on the results of calculations performed by the image processing circuit 20, the system control circuit 50 causes a zoom control circuit 44 to perform a predetermined zoom operation.

As noted above, reference numeral 22 denotes the memory control circuit. The memory control circuit 22 controls the A/D converter 16, the timing generator circuit 18, the image processing circuit 20, an image display memory 24, a D/A converter 26, a memory 30 and a compression/decompression circuit 32.

Then, image data that is A/D converted by the A/D converter 16 is written to the image display memory 24 or the memory 30 via the image processing circuit 20 and the memory control circuit 22, or written to the image display memory 24 or the memory 30 via the memory control circuit 22.

As noted above, reference numeral 24 denotes the image display memory and reference numeral 26 denotes the D/A converter. Reference numeral 28 is an image display unit consisting of a TFT (Thin Film Transistor) or an LCD (Liquid Crystal Display).

The image data written to the image display memory 24 is displayed by the image display unit 28 via the D/A converter 26. By successively displaying the image data on the image display unit 28 it is possible to implement an electronic viewfinder function.

Additionally, the image display unit 28 can turn the display ON or OFF according to instructions from the system control circuit 50. When the display is turned OFF, the amount of power consumed by the image reproduction apparatus 100 can be reduced.

The memory 30 stores acquired still images and moving images. The memory 30 is provided with enough storage capacity to store a predetermined number of still images or a predetermined amount of time of moving pictures.

The above-described arrangement makes it possible not only to write images at high speed to the memory 30 but also to write a large number of images to the memory 30, even when snapping a plurality of still image photos in sequence or in panorama. Moreover, the memory 30 can also be used as a work area for the system control circuit 50.

As noted above, reference numeral 32 denotes the compression/decompression circuit that compresses and decompresses image data using adaptive discrete cosine transform (ADCT) or the like. The compression/decompression circuit 32 reads out and either compresses or decompresses image data stored in the memory 30, after which the image data that is either compressed or decompressed is rewritten to the memory 30.

As noted above, reference numeral 50 denotes the system control circuit that controls the entire image reproduction apparatus 100. Reference numeral 52 denotes a memory for storing constants, variables, programs and the like used when the system control circuit 50 operates.

Reference numerals 60, 62, 66 and 68 denote controls for inputting operating instructions destined for the system control circuit 50, and consist of switches, dials and the like.

A detailed description is now given of these controls. Thus, reference numeral 60 denotes a mode switching switch. By operating this switch, a user can switch between an image sensing mode, a reproduction mode and multi-screen reproduction mode, etc.

Reference numeral 62 denotes a shutter switch. The user instructs the apparatus to begin image sensing by pressing this shutter switch 62. Reference numeral 66 denotes an image display ON/OFF switch. By operating this switch, the user can turn the image display unit 28 display ON or OFF.

By using the image display ON/OFF switch to turn the image display unit 28 display OFF, the supply of electric current to the image display unit 28 composed of a TFT and an LCD can be cut off when using the optical viewfinder 104 for image sensing, thereby reducing power consumption.

Reference numeral 68 denotes an image forwarding switch for forwarding an image displayed on the image display unit 28. The image forwarding switch 68 is operated when the mode switching switch 60 is set to reproduction mode.

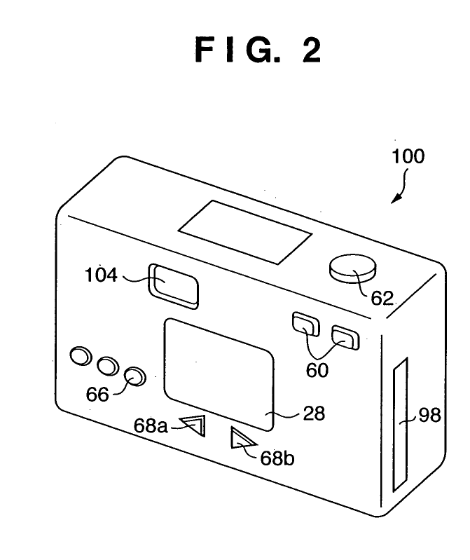

Additionally, the image forwarding switch 68 is composed of a left button 68a for forwarding to the last image and a right button 68b for forwarding to the next image, as shown in FIG. 2 to be described below.

Reference numeral 80 denotes a power supply control circuit. The power supply control circuit 80 is connected to a detachable power supply 86 via connectors 82, 84.

Reference numeral 90 denotes an interface with a detachable recording medium 200 such as a memory card, a hard disk or the like. Reference numeral 92 denotes a connector for effecting a connection between the detachable recording medium 200 such as a memory card, a hard disk or the like.

It should be noted that the interface 90 and the connector 92 are also configured so as to be able to transmit image data to and from peripheral devices such as other computers, printers and the like.

As noted above, reference numeral 200 denotes the detachable recording medium consisting of a memory card, a hard disk or the like. The recording medium 200 is provided with a recording unit 202, an interface (I/F) 204 to the image reproduction apparatus 100 and a connector 206 for effecting a connection with the image reproduction apparatus 100. In addition, the image reproduction apparatus 100 is also provided with a flash 48 and a non-volatile memory 56.

FIG. 2 is a diagram showing an external view mainly of a rear surface of an image reproduction apparatus according to an embodiment of the present invention. It should be noted that members that are the same as those shown in FIG. 1 are given the same reference numerals.

In particular, reference numeral 104 denotes the optical viewfinder. By looking through the optical viewfinder 104, the user can observe an image to be photographed without using the electronic viewfinder function of the image display unit 28.

Additionally, reference numeral 98 denotes a port for attaching and detaching the detachable recording medium 200. As noted above, the image forwarding switch 68 has a left button 68a and a right button 68b.

If the left button 68a is pressed once during the aforementioned reproduction mode, the immediately preceding image (that is, the last image) is displayed on the image display unit 28. If the right button 68b is pressed once during the aforementioned reproduction mode, the immediately succeeding image (that is, the next image) is displayed on the image display unit 28. A detailed description of the operating specifications of the left button 68a and the right button 68b is given later.

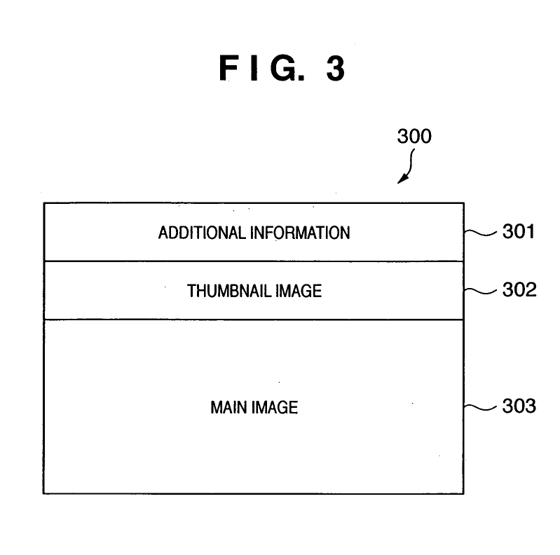

FIG. 3 is a diagram showing one example of a file structure of an image file recorded by an image reproduction apparatus according to an embodiment of the present invention. It should be noted that the present embodiment is described with reference to an example in which the commonly known JPEG format is used to compose the image file.

In FIG. 3, reference numeral 300 denotes a single JPEG image file. Reference numeral 303 denotes an area containing a main image as a first image used when viewing the image on the display screen of another computer (PC) or printing the image with a printer. It should be noted that, in the present embodiment, the main image is also used when displaying on the image display unit 28, as is described later. Reference numeral 301 denotes a region in which additional information such as image sensing information attached to the JPEG image file 300 is written. For example, a variety of EXIF-standard information is written to this region.

Reference numeral 302 denotes a region containing a thumbnail image as a second image that is a low-resolution version of the main image. This thumbnail image is used when displaying a list of images or the like on the image display unit 28.

The above-described thumbnail image is compressed and stored by the compression/decompression circuit 32, with the respective region images decompressed and displayed when displayed. However, sometimes the above-described thumbnail images are not compressed.

An image file 300 having the type of structure described above is recorded on the recording medium 200 after image sensing. The recorded image file 300 is then retrieved during the above-described reproduction mode, and the required region of the image file 300 so retrieved is decompressed by the compression/decompression circuit 32 and once stored in the image display memory 24.

Then, the image recorded in the required region of the image file 300 once stored in the image display memory 24 is displayed on the image display unit 28 via the D/A converter 26. It should be noted that the routine involved in the image sensing mode of the present embodiment is a commonly known routine and so an explanation thereof is omitted herein.

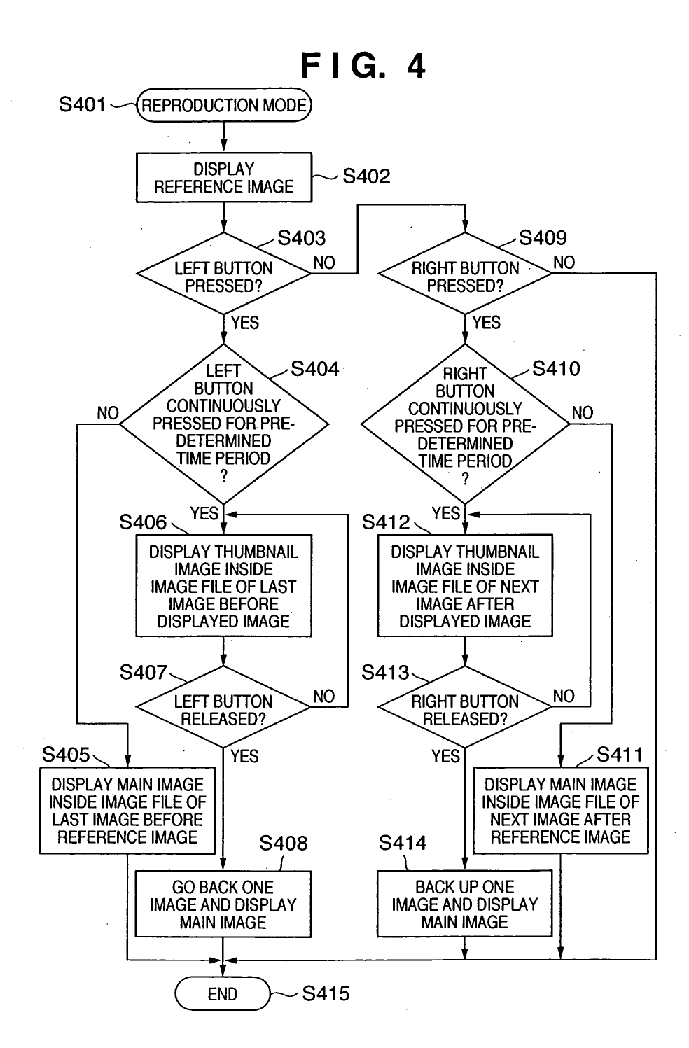

Next, a description is given of the operation of the image reproduction apparatus 100 according to the present embodiment during reproduction mode with reference to the flow chart shown in FIG. 4.

FIG. 4 is a flow chart illustrating operation during a reproduction mode of an image reproduction apparatus according to an embodiment of the present invention.

First, in an initial step S401, when the user operates the mode switching switch 60 to put the apparatus into reproduction mode, the reproduction mode routine is begun.

Next, in a step S402, the memory control circuit 22 displays a reference image on the image display unit 28 (step S402). If directly after image sensing, the reference image is that sensed image. Alternatively, if the detachable power supply 86 to the image reproduction apparatus 100 has just been turned ON, the reference is the first image stored in the recording medium 200.

It should be noted that a plurality of image files stored in the recording medium 200 are ordered by file number or by file name.

Next, in a step S403, the system control circuit 50 determines whether or not the left button 68a for advancing the images in a reverse direction (that is, in a direction of an image file arranged in order so as to come before the above-described reference image) has been pressed by the user.

If the results of the foregoing determination indicate that the left button 68a has been pressed, the process then proceeds to a step S404 and the system control circuit 50 then further determines whether or not the left button 68a continues to be pressed.

If the results of that further determination indicate that the left button 68a does not continue to be pressed (that is, the left button 68a has only been pressed once in a brief time period), then the process proceeds to a step S405.

In the step S405, the memory control circuit 22 uses the compression/decompression circuit 32 to decompress the main image data in the image file 300 at the last image before the reference and displays the decompressed file on the image display unit 28.

It should be noted that if the reference image happens to correspond to the first image in the sequence of the plurality of image files, then the image displayed is the main image in the image file of the last image in the sequence, that is, the sequence is cyclical. The process then proceeds to a step S415 and the image displayed on the image display unit 28 continues to be displayed.

If in the above-described step S404 it is determined that the left button 68a continues to be pressed for a predetermined time period, then the process proceeds to a step S406 for searching the image files 300 in the reverse direction and to a step S407 to begin the display operation.

That is, in step S406, the memory control circuit 22 uses the compression/decompression circuit 32 to decompress the thumbnail image in the image file 300 at the last image before the reference image and to display that decompressed image on the image display unit 28.

In step S407, the system control circuit 50 determines whether or not the left button 68a continues to be pressed, and, if so, returns the process to step S406, where the memory control circuit 22 uses the compression/decompression circuit 32 to decompress the thumbnail image in the image file 300 before the last image and displays the decompressed image on the image display unit 28.

The routines contained in steps S406 and S407 are repeated for as long as the left button 68a continues to be pressed, decompressing the thumbnail images one after another in the reverse direction and displaying the decompressed images on the image display unit 28.

Since the thumbnail images displayed on the image display unit 28 one after another at high speed as described above are low-resolution images, such that the user can only ascertain the general outlines of the images and no more, nevertheless these low-resolution images are sufficient for the user to ascertain whether or not the image is the one the user wishes to see.

Accordingly, when the user does ascertain that the image displayed is the image that the user wishes to see, the user releases the left button 68a and thereby halts the high-speed search of the image files 300 of step S406 and the display operation of step S407, and the process then proceeds to a step S408 (YES in step S407).

In the above-described manner, then, the user, after ascertaining that the thumbnail image corresponding to the image that the user wishes to see is displayed on the image display unit 28, releases the left button 68a. Yet the image forwarding operation carried out by the routines of step S406 and step S407 as described above takes place at the speed of several frames per second.

Accordingly, typically, the thumbnail image being displayed on the image display unit 28 when the image reproduction apparatus 100 detects that the user has released the left button 68a is not the image that the user wishes to see, because the image that the user wishes to see has already been displayed and passed.

Thus, in view of this dual time lag, in step S408, the image reproduction apparatus 100 backs up one image file from the image file 300 corresponding to the thumbnail image displayed at the time the apparatus detects that the user has released the left button 68a, to the image file 300 corresponding to the thumbnail image of the last image displayed before the thumbnail image displayed at the time the apparatus detects that the user has released the left button 68a. The image reproduction apparatus 100 then decompresses that image and displays that decompressed image on the image display unit 28. The process then proceeds to step S415 and the image displayed on the image display unit 28 continues to be displayed.

If in step S403 it is determined that the left button 68a has not been pressed, then the process proceeds to a step S409 and the system control circuit 50 determines whether or not the right button 68b that advances the images in a forward direction (that is, in a direction of an image file arranged in order so as to come after the above-described reference image) has been pressed by the user.

If the results of the foregoing determination in step S409 indicate that the right button 68b has not been pressed, the process then proceeds to step S415 and the reference image continues to be displayed on the image display unit 28.

On the other hand, if the results of determination performed in step S409 indicate that the right button 68b has been pressed, then the process proceeds to a step S410 and the system control circuit 50 further determines whether or not the right button 68b continues to be pressed.

If the results of that further determination indicate that the right button 68b has only been pressed once in a brief time period without continuing to be pressed, then the process proceeds to a step S411.

In step S411, the memory control circuit 22 uses the compression/decompression circuit 32 to decompress the main image in the next image file 300 after the reference image and displays the decompresses image on the image display unit 28. The process then proceeds to step S415 and the image displayed on the image display unit 28 continues to be displayed.

Additionally, when it is detected in step S410 described above that the right button 68b continues to be pressed, then the image reproduction apparatus 100 advances the process to step S412, where the image files 300 are searched at high speed in the forward direction, and begins the display operation of step S413.

That is, in step S412, the memory control circuit 22 uses the compression/decompression circuit 32 to decompress the thumbnail image in the next image file 300 after the reference image and displays the decompressed image on the image display unit 28.

Then, in step S413, the system control circuit 50 continues to determine whether or not the right button 68b continues to be pressed, and, if so, returns the process to step S412, where the memory control circuit 22 uses the compression/decompression circuit 32 to decompress the thumbnail image in the image file 300 after the next image and displays the decompressed image on the image display unit 28.

The routines contained in steps S412 and S413 are repeated for as long as the right button 68b continues to be pressed, decompressing the thumbnail images one after another in the forward direction and displaying the decompressed images on the image display unit 28.

Thereafter, when the user releases the right button 68b, the process proceeds to step S414 and the image reproduction apparatus 100 decompresses the main image in the image file 300 one image before the image file 300 corresponding to the thumbnail image displayed at the time the image reproduction apparatus 100 detects that the user has released the right button 68b and displays that decompressed main image on the image display unit 28. The process then proceeds to step S415 and the image displayed on the image display unit 28 continues to be displayed.

In the present embodiment as described above, when the image forwarding switch 68 continues to be pressed for a predetermined time period, low-resolution thumbnail images are displayed on the image display unit 28 one after another in succession. When the image forwarding switch 68 is released during this display of low-resolution thumbnail images, the apparatus displays the main image in the same image file 300 as the thumbnail image displayed one image prior to the thumbnail image displayed at the time the image forwarding switch 68 is released, so a high-resolution main image can be displayed that takes into account the time lag between the point at which it is detected that the user has released the image forwarding switch 68 and the point at which the target thumbnail image is displayed. Accordingly, when attempting to display the target image from among a large number of images recorded on the recording medium, the target image can be comfortably reached even while using a high-speed search function.

In other words, even when the user releases the image forwarding switch 68 after ascertaining that the target thumbnail image that the user wishes to see has been displayed during high-speed search, despite the fact that in actuality the thumbnail image display has already been passed, the desired image is instantaneously displayed at high resolution, so the displeasure felt at passing the image can be mollified. Accordingly, by fast forwarding through the display of the thumbnail images the length of time needed to arrive at and display any given image can be reduced, and at the same time a high-resolution display of the main image that the viewer wishes to see can be achieved.

It should be noted that, in the present embodiment, matters have been arranged so that what is displayed is the main image in the image file 300 corresponding to either the last image before, or the next image after, the thumbnail image being displayed on the image display unit 28 when the user releases the image forwarding switch 68. In other words, the amount by which the desired image is overshot is assumed to be one image.

However, this amount (that is, this overshoot amount) varies according to the thumbnail image display switching speed (the image forwarding speed). Also, the overshoot amount changes depending on whether or not the user is familiar with the image reproduction apparatus 100. Accordingly, it is also possible to change (that is, to set) the overshoot amount according to the above-described factors (i.e., the number of thumbnail images displayed per second and the degree of user familiarity with the apparatus).

For example, if the frame forwarding speed is set to gradually increase as the length of time for which the image forwarding switch 68 is continuously pressed grows, then the number of images by which the display is backed up is also increased, because the point in time at which the button is released after high-speed searching is commenced comes later as well.

Additionally, the above-described overshoot amount can also be set according to a standard user reaction speed. Further, it is also possible to have the image reproduction apparatus 100 learn the user's reaction speed and to change (that is, set) the overshoot amount according to that learned reaction speed.

For example, when matters are arranged so that, even if the value for the number of images by which the display is to be backed up is initially set at 1, the apparatus displays the image apparatus 3 frames before the thumbnail image displayed at the time high-speed searching was finished whenever the image forwarding switch 68 is operated after the user has finished the high-speed search and displayed the main image, the image reproduction apparatus learns this amount as the user reaction speed and sets the number of frames by which the image display is backed up to 3 images.

Additionally, the overshoot amount may also be arbitrarily designated by user setting. Further, it is also possible to set the apparatus so as to detect the pressure of input from the image forwarding switch 68, to change the image forwarding speed depending on the user input pressure, and further, to vary the above-described overshoot amount accordingly as well.

Additionally, in the present embodiment, the instruction for entering the process of searching the image files 300 at high speed is carried out by pressing the image forwarding switch 68 provided as an operating member. However, for example, the apparatus may be configured so that a rotating dial is provided as the control member instead of the switches described above, with the apparatus entering the process of searching the image files 300 at high speed when the rotating dial is rotated at a predetermined speed.

Additionally, instead of a configuration in which the overshoot amount is varied by the input pressure of the image forwarding switch 68 provided as an operating member in the form of a button as described above, it is also possible to provide a joystick-type input member as an operating member, and varying the overshoot amount by the angle of tilt of such a joystick-type input member.

Moreover, although in the present embodiment, as explained using FIG. 3, there are two images contained in a single image file, that is, a main image 303 and a thumbnail image 302, the present invention is not limited to such an arrangement. Thus, for example, an image having a resolution intermediate between the low-resolution image thumbnail image and the high-resolution image main image may be further include in the image file as will, and this intermediate resolution image displayed during high-speed search, without using the low-resolution thumbnail image. In other words, a single image file may be made to contain images of several different resolutions, with lower-resolution images displayed during high-speed search and the higher-resolution image, contained in the image file at a predetermined prior number of images prior thereto, displayed when the high-speed search is stopped.

Thus, as described above, the form of the control member and the content of the operations performed by the user via the operating member when entering the process of searching the image files 300 at high speed is not limited to that which is described with respect to the above-described present embodiment.

Thus, as described above, according to the present invention, when displaying a plurality of image file images based on user operation of an operating member and that control member is put into a predetermined operating state, low-resolution images included in each of the image files are displayed one after another in succession, during which time, if the predetermined operating state is released, the apparatus displays a high resolution image in the same image file as the low-resolution image displayed a predetermined number of images before the low-resolution image displayed at the time the predetermined operating state is released, so a high-resolution main image can be displayed that takes into account the time lag between when the user releases the control member and when the low-resolution images is displayed.

Accordingly, when searching for a desired image among a plurality of image file images, for the images that are not the object of the search the time needed to display a given image can be reduced by fast-forwarding through the low-resolution images, and for the image that is the object of the search, a high-resolution image requiring time for decompression can be displayed promptly. By so doing, the user can quickly and easily search for a desired image among a large number of images.

Note that the present invention can be applied to an apparatus comprising a single device or to a system constituted by a plurality of devices.

Furthermore, the invention can be implemented by supplying a software program that implements the functions of the foregoing embodiments directly or indirectly to a system or apparatus, reading the supplied program code with a computer of the system or apparatus, and then executing the program code. In this case, so long as the system or apparatus has the function of the program, the mode of implementation need not rely upon a program.

Accordingly, since a computer implements the functions of the present invention, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or part of the actual processing so that the functions of the foregoing embodiment can be implemented by the is processing.

As many apparently widely different embodiments of the present invention can be made without departing from the spirit and scope thereof, it is to be understood that the invention is not limited to the specific preferred embodiments described above thereof except as defined in the claims.

What is claimed is:

1. An image reproduction apparatus comprising:
a memory that stores a plurality of image files, each image file having a file structure that includes at least two images, a high-resolution first image and a low-resolution second image, for any single image;
a display unit that displays an image file according to the plurality of image files stored in the memory;
an operating unit operated by a user for forwarding images displayed on the display unit; and
a control unit that successively fast forwards the second low-resolution images according to the plurality of image files while the operating unit is in a predetermined operating state and displays the first image corresponding to the second image displayed a predetermined number of images prior to the second image displayed when the operating unit is released from the predetermined operating state.

2. The image reproduction apparatus according to claim 1, wherein the predetermined operating state is a state maintained continuously by the operating unit at a predetermined operating position for a predetermined time period.

3. The image reproduction apparatus according to claim 1, further comprising setting means for setting the predetermined number of images depending on the fast forward speed.

4. The image reproduction apparatus according to claim 1, wherein the predetermined number of images is set according to how the user operates the operating unit with respect to the fast forwarding display.

5. The image reproduction apparatus according to claim 1, further comprising a setting unit by which the user sets the predetermined number.

6. The image reproduction apparatus according to claim 1, wherein the first image is fast forward displayed when the operating unit is not in the predetermined operating state.

7. An image reproduction method for an image reproduction apparatus, the apparatus displaying on a display unit images according to image files from a memory that stores a plurality of the image files, each image file having a file structure that includes at least two images, a high-resolution first image and a low-resolution second image, for any single image, the method comprising the steps of:
successively fast forwarding the second images when an operating unit that fast forwards image is in a predetermined operating state; and
displayed a first image corresponding to a second image displayed a predetermined number of images prior to the second image displayed when the user releases the operating unit form the predetermined operating state.

8. A program for causing an image reproduction apparatus to display on a display unit images according to image files from a memory that stores a plurality of the image files, each image file having a file structure that includes at least two images, a high-resolution first image and a low-resolution second image, for any single image, the program comprising:
code for successively fast forwarding the second images when an operating unit that fast forwards images is in a predetermined operating state; and
code for displaying a first image corresponding to a second image displayed a predetermined number of images prior to the second image displayed when the user releases the operating unit form the predetermined operating state.
